(19) United States
(12) Patent Application Publication
(10) Pub. No.: US 2009/0311020 A1
(43) Pub. Date: Dec. 17, 2009

(54) AUTO DOCUMENT FEEDING DEVICE AND FEEDING METHOD

(75) Inventors: Naoki Shoji, Kanagawa (JP); Shoichi Taniguchi, Shizuoka (JP); Masashi Akiyama, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/485,502

(22) Filed: Jun. 16, 2009

Related U.S. Application Data
(60) Provisional application No. 61/061,999, filed on Jun. 16, 2008.
(60) Provisional application No. 61/079,737, filed on Jul. 10, 2008.
(60) Provisional application No. 61/079,741, filed on Jul. 10, 2008.

(51) Int. Cl. G03G 15/00

(52) U.S. Cl. 399/367

(57) ABSTRACT

An auto document feeding device of an embodiment includes triple paper discharge rollers forming an upper paper discharge port for discharging a document at the time of one-sided reading and a lower paper discharge port for discharging a document reversed at the time of both-sided reading. A flap which covers the lower discharge port by its own weight and opens the lower discharge port by being pressed by the document discharged from the lower discharge port is provided on a shaft member of the triple paper discharge rollers.

### CROSS REFERENCE TO RELATED APPLICATION

This invention is based upon and claims the benefit of priority from Provisional U.S. Patent Applications 61/061999 filed on Jun. 16, 2008, 61/079737 filed on Jul. 10, 2008 and 61/079741 filed on Jul. 10, 2008 the entire consents of which are incorporated herein by reference.

### TECHNICAL FIELD

The present invention relates to an auto document feeding device which is used for image reading in a copier, a printer or the like and automatically feeds a document.

### BACKGROUND

In a document feeding device used in an automatic document reading apparatus to read images of both sides of a document, there is a device to switch back the document when the document is fed in a both-sided reading mode. For example, U.S. Pat. No. 6,522,860B2 discloses a device to switch back a document by using triple rollers.

In the triple rollers, a center drive roller simultaneously drives upper and lower driven rollers, and a document is switched back. The upper and the lower driven rollers of the triple rollers rotate in opposite directions through the drive roller. For example, while the upper driven roller and the drive roller temporarily feed a document to a space above a storage tray, the lower driven roller and the drive roller operate in a direction of pulling a document into the inside of the feeding device from the storage tray. Thus, when a document is fed to the space above the storage tray in order to switch back the document, for example, when a document in the storage tray contacts with the lower driven roller or the drive roller, there is a fear that the document is again pulled into the feeding device by the lower driven roller and the drive roller. Further, the triple rollers are used in a paper discharge section, and when a document is discharged to the storage tray by, for example, the upper driven roller and the drive roller, there is a fear that the trailing edge of the document is again pulled into the feeding device by the lower driven roller and the drive roller.

In an automatic document reading apparatus, the development of an auto document feeding device is desired in which feeding speed, and by extension, reading speed of a document are increased when both sides of a document are read, and it is prevented that the document is unnecessarily pulled into the inside of the device while triple rollers drives in a direction in which the document is discharged.

### SUMMARY

An aspect of the invention is to prevent a document, which is discharged after completion of reading by using triple rollers in a discharge section, from being again pulled into an auto document feeding device and to smoothly discharge the document.

According to an embodiment, an auto document feeding device includes a first rotation member which can feed a document passing through a reading member in a first direction and a second direction opposite to the first direction, a second rotation member to drive the first rotation member, a third rotation member which is positioned below the first rotation member through the second rotation member and is driven by the second rotation member, a reverse feeding member to feed the document from a first discharge port for discharging the document in the first direction by using the first rotation member and the second rotation member to a second discharge port for discharging the document by using the second rotation member and the third rotation member, a placing member on which the document discharged through the first discharge port in the first direction or the document discharged through the second discharge port is placed, and a covering member to open and close an outlet side of the second discharge port to the placing member.

### DESCRIPTION OF THE DRAWINGS

FIG. 1 is an explanatory view schematically showing an automatic document reading apparatus on which an auto document feeder of a first embodiment is mounted;

FIG. 2 is a structural view schematically showing a part of the auto document feeder of the first embodiment;

FIG. 3 is a block diagram showing a control system which mainly relates to the auto document feeder of the first embodiment;

FIG. 4 is a schematic perspective view showing paper discharge rollers in the first embodiment;

FIG. 5 is a schematic perspective view showing support of a flap by a drive shaft in the first embodiment;

FIG. 6 is a schematic explanatory view showing attachment of the flap to the drive shaft in the first embodiment;

FIG. 7 is a schematic perspective view showing the flap and a charge removable brush in the first embodiment;

FIG. 8 is a schematic explanatory view showing winding of the charge removal brush to the drive shaft in the first embodiment;

FIG. 9 is a schematic perspective view showing covering of a lower discharge port by the flap in the first embodiment;

FIG. 10 is a schematic explanatory view showing swinging of the flap in the first embodiment;

FIG. 11 is a schematic explanatory view showing a feeding process at the time of one-sided reading in the first embodiment;

FIG. 12 is a schematic explanatory view showing a preceding document at the time of both-sided reading and at the time of feeding to a reverse path in the first embodiment;

FIG. 13 is a schematic explanatory view showing reversal of the preceding document at the time of both-sided reading in the first embodiment;

FIG. 14 is a schematic explanatory view showing feeding of the preceding document to a paper discharge path at the time of both-sided reading in the first embodiment;

FIG. 15 is a schematic explanatory view showing the start of reversal of the preceding document at the time of both-sided reading in the first embodiment;

FIG. 16 is a schematic explanatory view showing paper discharge of the preceding document and feeding of a subsequent document to the reverse path at the time of both-sided reading in the first embodiment;

FIG. 17 is a schematic explanatory view showing paper discharge rollers in a second embodiment;

FIG. 18 is a schematic explanatory view showing an operation of the paper discharge rollers in the second embodiment;

FIG. 19 is a schematic explanatory view showing a paper discharge path in a third embodiment;

FIG. 20 is a schematic explanatory view showing a paper discharge process at the time of one-sided reading in the third embodiment;

FIG. 21 is a schematic explanatory view showing a document at the time of both-sided reading and at the time of feeding to a reverse path in the third embodiment;

FIG. 22 is a schematic explanatory view showing reversal of the document at the time of both-sided reading in the third embodiment; and

FIG. 23 is a schematic explanatory view showing paper discharge of the document at the time of both-sided reading in the third embodiment.

### DETAILED DESCRIPTION

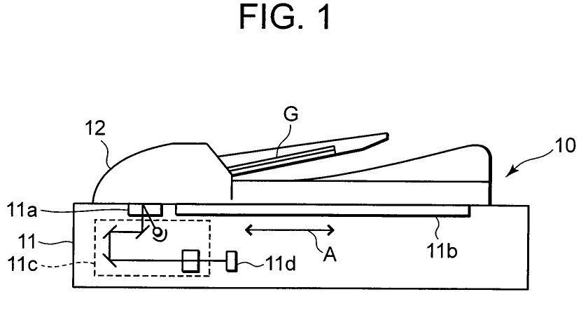

Hereinafter, a first embodiment will be described with reference to the accompanying drawings. FIG. 1 is a schematic structural view showing an automatic document reading apparatus 10 of the first embodiment. The automatic document reading apparatus 10 includes a scanner 11 as a reading member, and an auto document feeder (ADF) 12 as an auto document feeding device to feed a document to the scanner 11.

The scanner 11 includes a READ document glass 11a and a platen glass 11b. The scanner 11 includes an optical mechanism 11c. The optical mechanism 11c optically reads an image of a document G running on the READ document glass 11a. The optical mechanism 11c reads the image of the document G, which is moved along the platen glass 11b in an arrow a direction of FIG. 1 by a not-shown drive unit and placed on the platen glass 11b optically. The scanner 11 includes a CCD (Charge Coupled Device) 11d to photoelectrically convert an optical signal from the optical mechanism 11c into an electric signal.

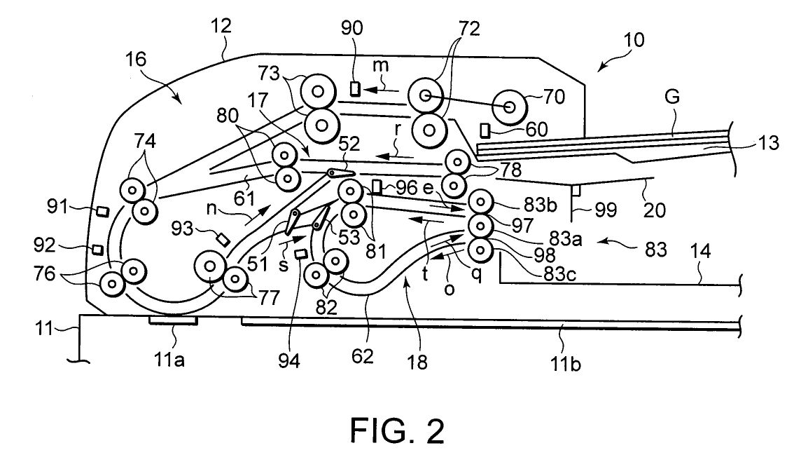

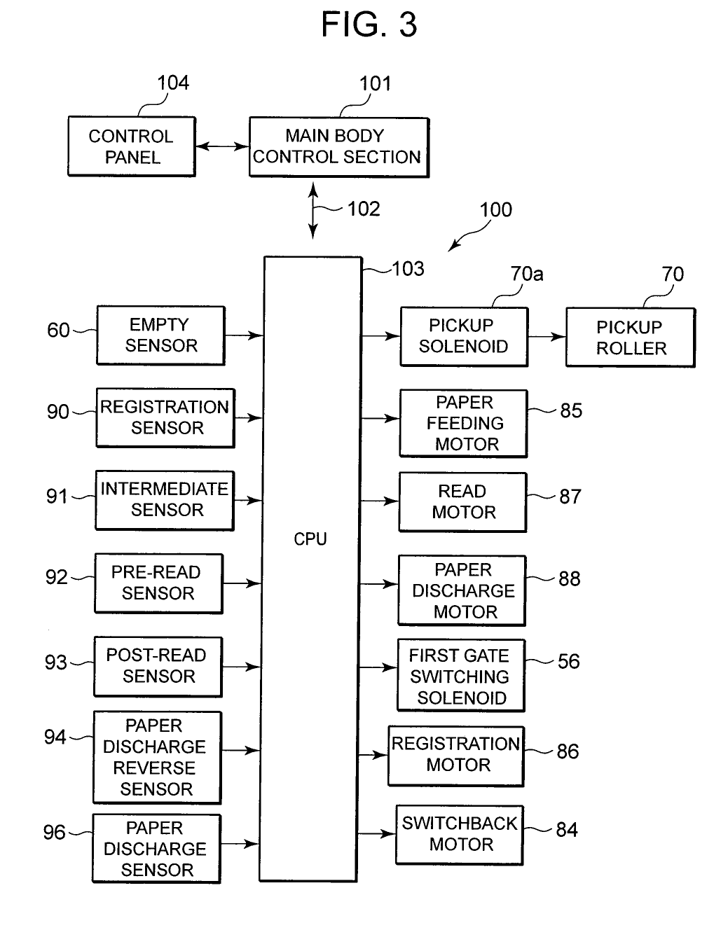

FIG. 2 schematically shows a structure of the ADF 12. FIG. 3 is a block diagram of a control system 100 which mainly relates to the ADF 12. The ADF 12 includes a document tray 13, and a storage tray 14 which is a placing member and on which the document G discharged after completion of reading is placed. The document tray 13 includes an empty sensor 60 to detect the presence or absence of a document. The ADF 12 includes a paper feed path 16, a reverse path 17 and a paper discharge path 18 between the document tray 13 and the storage tray 14.

The paper feed path 16 includes a pickup roller 70, a separation roller 72, a registration roller 73, an intermediate feeding roller 74, and a pre-read roller 76. A paper feeding motor 85 drives the pickup roller 70 and the separation roller 72. A registration motor 86 drives the registration roller 73. A pickup solenoid 70a swings the pickup roller 70.

The reverse path 17 includes a post-read roller 77, a reverse tray 20, a reverse roller 78, and a reverse registration roller 80. The reverse path 17 includes a first guide 61 extending from the reverse roller 78 to the intermediate feeding roller 74 via the reverse registration roller 80. A read motor 87 drives the intermediate feeding roller 74, the pre-read roller 76, the post-read roller 77 and the reverse registration roller 80. A switchback motor 84 drives the reverse roller 78.

The paper discharge path 18 includes a paper discharge intermediate roller 81, a paper discharge reverse roller 82 and triple paper discharge rollers 83. The paper discharge path 18 includes a U-shaped second guide 62 as a reverse feeding path. The paper discharge intermediate roller 81, the paper discharge reverse roller 82 and the second guide 62 constitute a reverse feeding member to guide the document from an upper discharge port 97 as a first discharge port to a lower discharge port 98 as a second discharge port of the paper discharge rollers 83.

The paper feed path 16 includes a registration sensor 90, an intermediate sensor 91, and a pre-read sensor 92. The registration sensor 90 detects the arrival of the document G at the registration roller 73. The intermediate sensor 91 and the pre-read sensor 92 are used for the driving timing of the paper feeding motor 85 and the read motor 87. The reverse path 17 includes a post-read sensor 93. The post-read sensor 93 is used for the driving timing of the read motor 87 and the switchback motor 84. The paper discharge path 18 includes a paper discharge reverse sensor 94 and a paper discharge sensor 96. The paper discharge reverse sensor 94 and the paper discharge sensor 96 are used for the driving timing of a paper discharge motor 88.

The ADF 12 includes a first gate 51, a second gate 52 and a third gate 53. The first gate 51 distributes the document G to the direction of the reverse path 17 as the first direction or the direction of the paper discharge path 18 as the second direction. The first gate 51 is activated by a first gate switching solenoid 56. The second gate 52 guides the reversed document G in the direction of the READ document glass 11a. The second gate 52 is activated by its own weight. The third gate 53 guides the reversed document G in the direction of the storage tray 14 as the paper discharge direction. The third gate 53 always has rotating force in a counterclockwise direction of FIG. 2 by, for example, an elastic force of a coil.

In FIG. 3, a control panel 104 of an image forming apparatus 1 is connected to a main body control section 101 to control the whole image forming apparatus 1. The main body control section 101 controls a CPU 103 of the automatic document reading apparatus 10 through an input and output interface 102. The input side of the CPU 103 is connected with the empty sensor 60, the registration sensor 90, the intermediate sensor 91, the pre-read sensor 92, the post-read sensor 93, the paper discharge reverse sensor 94 and the paper discharge sensor 96. The output side of the CPU 103 is connected with the pickup solenoid 70a to swing the pickup roller 70, the switchback motor 84, the paper feeding motor 85, the registration motor 86, the read motor 87, the paper discharge motor 88 and the first gate switching solenoid 56.

The paper discharge rollers 83 include a drive roller 83a as a second rotation member, an upper driven roller 83b as a first rotation member and a lower driven roller 83c as a third rotation member. In the paper discharge rollers 83, the drive roller 83a and the upper driven roller 83b are used to discharge the document G from the upper discharge port 97 as the first discharge port. In the paper discharge rollers 83, the drive roller 83a and the lower driven roller 83c are used to discharge the document G from the lower discharge port 98 as the second discharge port. The ADF 12 includes a fixed charge removal brush 99 which is provided below the reverse tray 20 positioned below the document tray 13 and contacts with the document G discharged from the upper discharge port 97 to remove electricity.

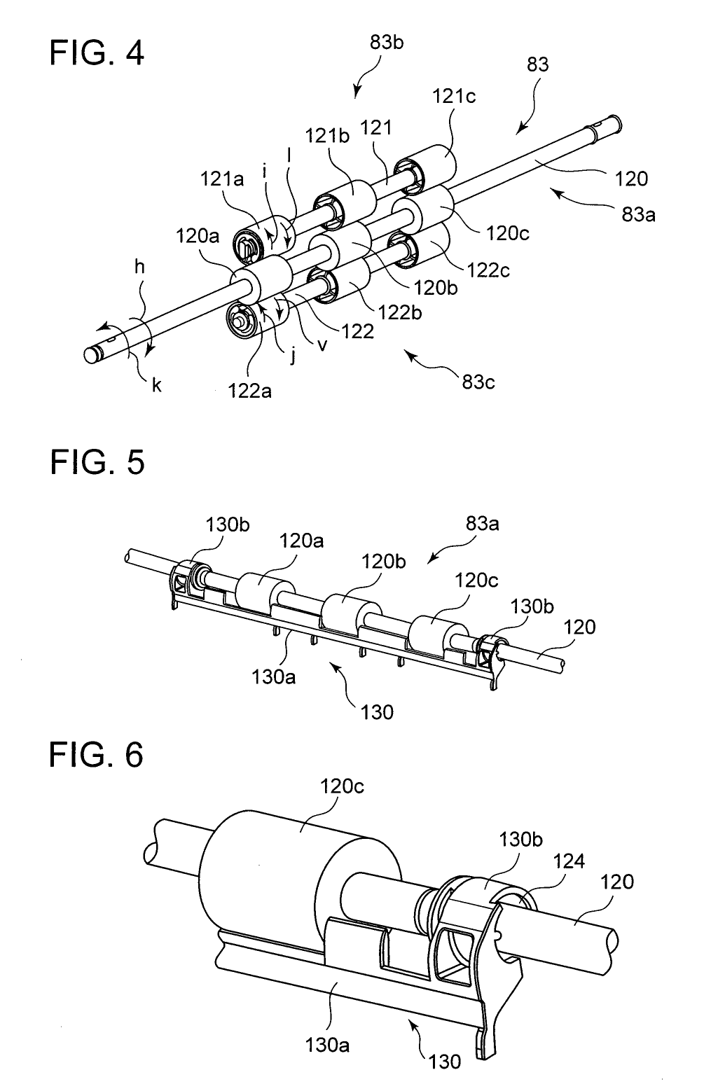

The structure of the paper discharge rollers 83 will be described. As shown in FIG. 4, the drive roller 83a includes the first to the third drive rollers 120a, 120b and 120c on a drive shaft 120. The upper driven roller 83b includes a first to a third upper driven rollers 121a, 121b and 121c on an upper shaft 121. The lower driven roller 83c includes a first to a third lower driven rollers 122a, 122b and 122c on a lower shaft 122. The first to the third upper driven rollers 121a, 121b and 121c respectively contact with the first to the third drive rollers 120a, 120b and 12c and are driven. The first to the third lower driven rollers 122a, 122b and 122c respectively contact with the first to the third drive rollers 120a, 120b and 120c and are driven.

When the drive roller 83a rotates, the upper driven roller 83b and the lower driven roller 83c are rotated in the reverse direction at the same timing. When the drive roller 83a forwardly rotates in an arrow h direction, the upper driven roller 83b is rotated in an arrow i direction, and the lower driven roller 83c is rotated in an arrow j direction. When the drive roller 83a reversely rotates in an arrow k direction, the upper driven roller 83b is rotated in an arrow 1 direction, and the lower driven roller 83c is rotated in an arrow v direction. When the drive roller 83a forwardly rotates, the upper driven roller 83b feeds the document G in an arrow e direction as shown in FIG. 2. The lower driven roller 83c attempts to pull the document G in an arrow o direction. When the drive roller 83a reversely rotates, the upper driven roller 83b pulls the document G in an arrow t direction as shown in FIG. 2. The lower driven roller 83c feeds the document G in an arrow q direction.

As shown in FIG. 5 and FIG. 6, the drive shaft 120 rotatably supports a hook section 130b of a flap 130 as a covering member. The hook section 130b has a hook shape (aduncate shape), and is mounted and fitted to the outer circumference of a metal bush 124 which is a conductive bearing member provided on the drive shaft 120. The bush 124 is provided on the drive shaft 120, so that the movement of the flap 130 is made smooth. A plane part 130a of the flap 130 is formed of, for example, a synthetic resin thin member, and swings around the drive shaft 120 as a fulcrum.

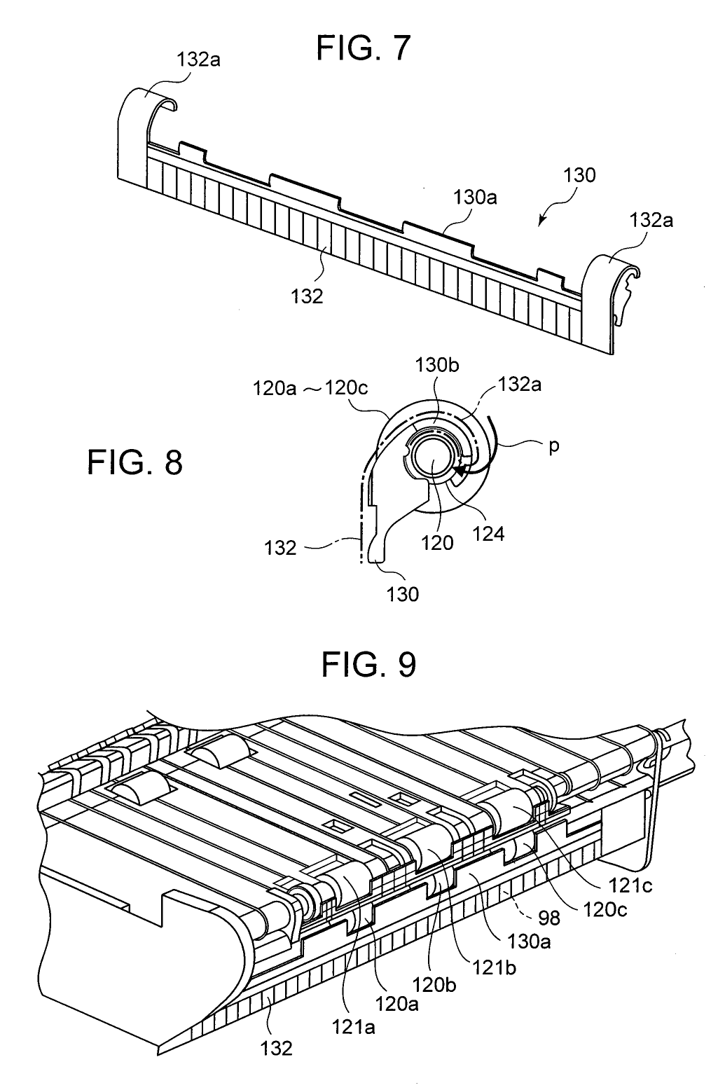

As shown in FIG. 7, the flap 130 includes a charge removal brush 132 as a charge removal member. The charge removal brush 132 is made of, for example, conductive nonwoven cloth, and is bonded to the plane part of the flap 130. Both ends 132a of the charge removal brush 132 extend long in the direction of the hook section 130b of the flap 130, and are formed to be rectangular. As shown in FIG. 8, each of both the ends 132a of the charge removal brush 132 extending in the direction of the hook section 130b is wound in the direction of the bush 124 as indicated by an arrow p from the side of the hook section 130b of the flap 130. Each of both the ends 132a of the charge removal brush 132 is fitted to the outer circumference of the bush 124. Each of both the ends 132a of the charge removal brush 132 is sandwiched between the hook section 130b and the bush 124. The charge removal brush 132 is grounded through the bush 124, the drive shaft 120 and the frame of the ADF 12. The charge removal brush 132 is grounded through the bush 124, so that grounding of the charge removal brush 132 is certainly performed.

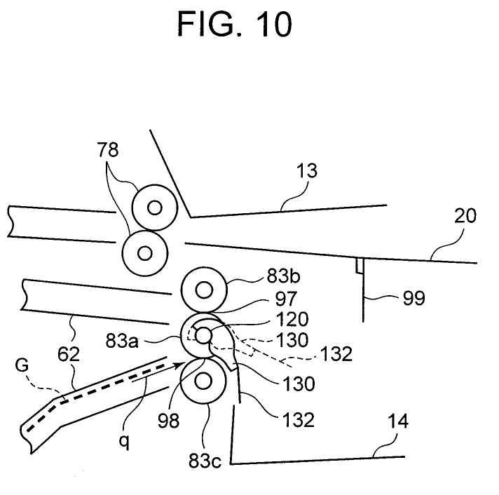

As shown in FIG. 9, the flap 130 covers the lower discharge port 98. As indicated by a solid line in FIG. 10, the flap 130 covers the lower discharge port 98 (nip part between the drive roller 83a and the driven roller 83c) by its own weight. When the document G discharged from the lower discharge port 98 in an arrow q direction presses the flap 130, the flap 130 opens the lower discharge port 98 as indicated by a dotted line in FIG. 10. The flap 130 can open the lower discharge port 98 by the pressing force of standard paper when the standard paper of a weight of 64 to 80 g/m² is discharged from the lower discharge port 98. In this embodiment, the flap 130 can open the lower discharge port 98 by a pressing force of 5 g or less. That is, the flap 130 is a covering member which is swung by a low load and openably and closably covers the lower discharge port.

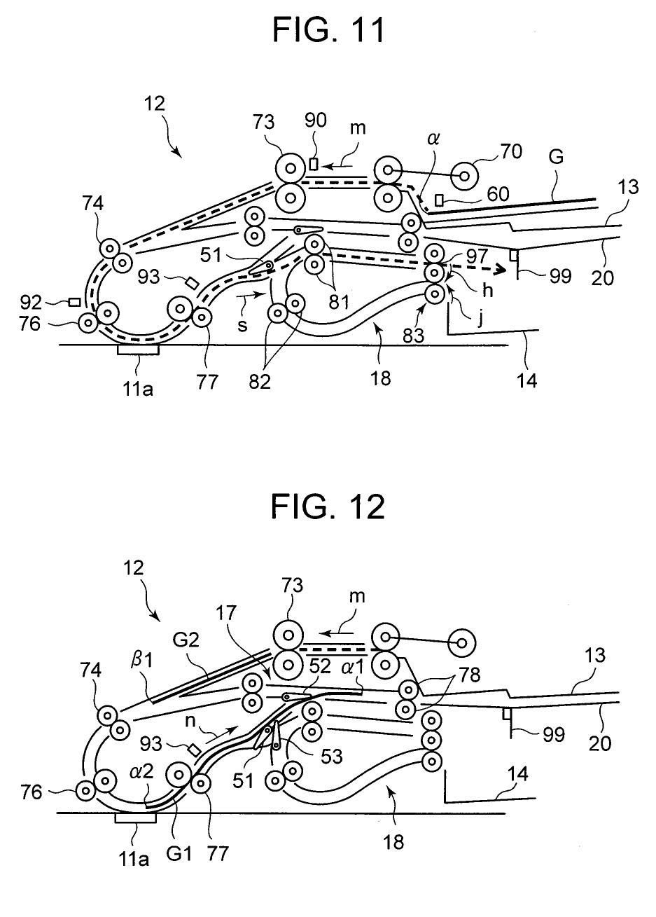

A document feeding process of the ADF 12 will be described. For example, a description will be given to the feeding process of a document of A4 size (210 mm×297 mm) of JIS (Japanese Industrial Standards) at the time of one-sided reading. As shown in FIG. 11, when a document G is set on the document tray 13, the empty sensor 60 is turned on. The Operator sets, together with various image formation conditions, one-sided feeding of the document G by the ADF 12 and starts the feeding operation of the document G by using the control panel 104. The paper feeding motor 85, the registration motor 86, the read motor 87 and the paper discharge motor 88 are driven at specified timings. The switchback motor 84 is not driven. The first gate switching solenoid 56 is turned off, and the paper discharge path 18 side is opened by the first gate 51.

When the feeding operation is started, the document G is fed from the document tray 13 in an arrow m direction. After a specified time passes since the registration sensor 90 is turned on, the paper feeding motor 85 is stopped. The leading edge a of the document G contacts with the registration roller 73 and the document G is aligned. The registration motor 86 is driven to rotate the registration roller 73 at high speed (pulling-in speed), and the document G is fed. The read motor 87 is driven, and the document G is fed at high speed (pulling-in speed) by the intermediate feeding roller 74 and the pre-read roller 76.

By turning on of the pre-read sensor 92, the scanner 11 reads the image of the document G in synchronization with the running of the document G on the READ document glass 11a. The document G passing through the READ document glass 11a advances in the direction of the paper discharge path 18 which is an arrow s direction. After the post-read sensor 93 is turned on, the paper discharge intermediate roller 81, the paper discharge reverse roller 82 and the paper discharge rollers 83 are rotated by driving of the paper discharge motor 88. The document G is nipped between the drive roller 83a and the upper driven roller 83b, is discharged from the upper discharge port 97 as the first discharge port, and is placed on the storage tray 14. The document G discharged from the upper discharge port 97 contacts with the fixed charge removal brush 99 and the electricity is removed before it is placed on the storage tray 14. Accordingly, the alignment of the document G is not disturbed by static electricity in the storage tray 14. The page order is not changed by the disturbance of the alignment of the document G, and the document is excellently aligned.

When the document G is discharged from the upper discharge port 97, the flap 130 covers the outlet side of the lower discharge port 98 by its own weight. The document G discharged from the upper discharge port 97 does not contact with the drive roller 83a or the lower driven roller 83c during the period when the document falls onto the storage tray 14. It is prevented that the trailing edge of the document G discharged from the upper discharge port 97 is again pulled in the direction of the paper discharge path 18 from the lower discharge port 98.

Next, the feeding process of a document at the time of both-sided reading of the document of A4 size will be described. At the time of both-sided reading, after an image of a first side of a preceding document G1 is read by a scanner 11 (α1 denotes the leading edge of the document G1, and α2 denotes the trailing edge of the document G1), the document G1 is again fed in the direction of the scanner 11 in order to read an image of a second side. As shown in FIG. 12, the ADF 12 feeds the document G1, whose image of the first side is read on the READ document glass 11a, in an arrow n direction toward the direction of the first gate 51 and the second gate 52. The reverse roller 78 temporarily feeds the document G1 passing through the second gate 52 in the direction of the reverse tray 20. At this time, a subsequent document G2 (β1 denotes the leading edge of the document G2, and β2 denotes the trailing edge of the document G2) passes through the registration roller 73 and stands by before the intermediate feeding roller 74.

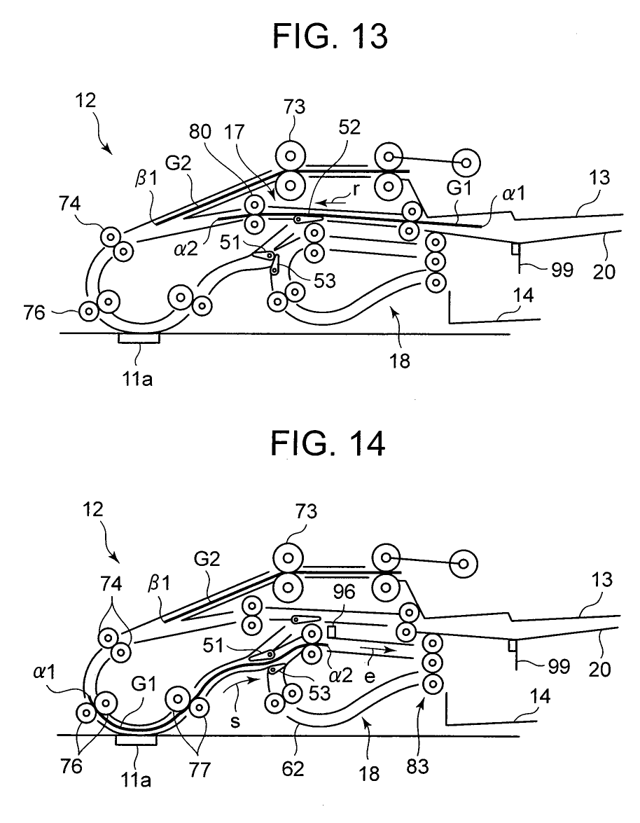

While the reverse roller 78 feeds the document G1 in the direction of the reverse tray 20, when the trailing edge α2 of the document G1 passes through the second gate 52 (a specified time passes after the post-read sensor 93 detects α2), the ADF 12 reverses and drives the reverse roller 78. As shown in FIG. 13, the reversed and driven reverse roller 78 switches back the document G1, which is temporarily fed in the direction of the reverse tray 20, in an arrow r direction. The reverse roller 78 feeds the document G1 in the direction of the reverse path 17.

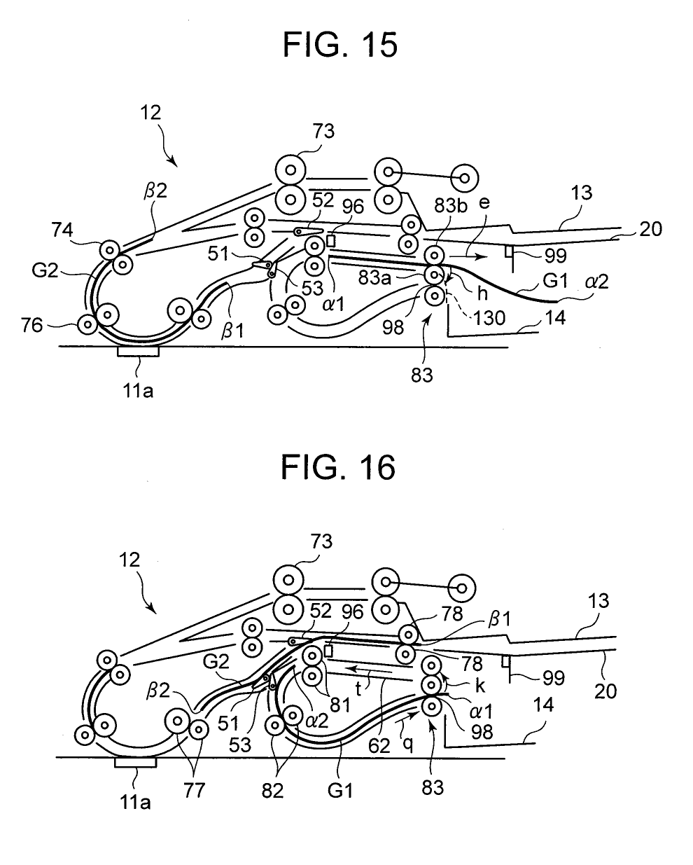

The ADF 12 feeds the switched back document G1 by the intermediate feeding roller 74 and the pre-read roller 76 in the direction of the READ document glass 11a while the trailing edge α2 is made the head. As shown in FIG. 14, the ADF 12 reads an image of a second side of the document G1 running on the READ document glass 11a. The ADF 12 feeds the document G1, whose image of the second side is read, in the direction of the paper discharge path 18. The ADF 12 switches the first gate 51 and feeds the document G1 in the direction of the second guide 62. As shown in FIG. 15, the ADF 12 feeds the document G1 running in the second guide 62 in an arrow e direction, by the drive roller 83a rotating in an arrow h and the upper driven roller 83b. The ADF 12 temporarily discharges the trailing edge α2 side of the document G1 above the storage tray 14 from the upper discharge port 97 of the triple paper discharge rollers 83. When the sheet size of the document G1 is small and the paper thickness is thin or curled, the temporarily discharged trailing edge α2 side may hang down in the direction of the lower driven roller 83c. Also at such a time, since the flap 130 covers the lower discharge port 98 of the triple paper discharge rollers 83, the document G1 hanging from the upper discharge port 97 does not contact with the lower driven roller 83c. Accordingly, the flap 130 prevents the document from being pulled in the direction of the paper discharge path 18 from the lower discharge port 98.

While the trailing edge α2 of the document G1 is temporarily discharged from the upper discharge port 97 to a space above the storage tray 14, the ADF 12 starts to read an image of a first side of the subsequent document G2. The first gate switching solenoid 56 switches the first gate 51 so as to guide the subsequent document G2 in the direction of the second gate 52.

When the leading edge al side of the document G1 fed in the arrow e direction passes through the paper discharge sensor 96, the ADF 12 stops the paper discharge motor 88 and reversely rotates it. As shown in FIG. 16, the drive roller 83a of the triple paper discharge rollers 83 rotates in the arrow k direction, and cooperates with the upper driven roller 83b to reverse (switchback) and feed the document G1 in the arrow t direction. The ADF 12 feeds the document G1 in the arrow t direction in the second guide 62, and feeds the document to the lower discharge port 98 of the discharge path 18 through the paper discharge intermediate roller 81 and the paper discharge reverse roller 82. The ADF 12 uses the drive roller 83a and the lower driven roller 83c to discharge the reversed and fed document G1 from the lower discharge port 98 as the second discharge port to the storage tray 14.

The document G1 is stacked on the storage tray 14 while the first side is directed downward. While the preceding document G1 is reversed in the paper discharge path 18, the subsequent document G2 runs on the READ document glass 11a, and is fed in the direction of the reverse tray 20 of the reverse path 17. Thereafter, similarly to the preceding document G1, the subsequent document G2 is reversed and fed along the reverse path 17. The ADF 12 reads an image of a second side of the document G2 reversed and fed along the reverse path 17, and feeds the document G2 in the direction of the paper discharge path 18.

Similarly to the preceding document G1, the ADF 12 reverses the subsequent document G2 in the paper discharge path 18. The document G2 is discharged from the lower discharge port 98 in the state where the first side is directed downward and the page order is aligned, and is stacked on the storage tray 14. When the document G1 or the document G2 is discharged from the lower discharge port 98 while pressing the flap 130, the document contacts with the charge removal brush 132 provided at the end of the flap 130 and the electricity is removed. Accordingly, the alignment of the document G1 or the document G2 is not disturbed in the storage tray 14 by static electricity. There is no fear that the alignment of the document G1 or the document G2 is disturbed and the page order is changed, and excellent alignment is performed. Further, when there are subsequent documents G3 to Gn, they are processed by the feeding process and at timings similar to the above.

According to the first embodiment, the flap 130 is provided which openably and closably covers the outlet side of the lower discharge port 98 of the triple paper discharge rollers 83 forming the upper discharge port 97 and the lower discharge port 98. The flap 130 prevents the document discharged from the upper discharge port 97 from contacting with the lower driven roller 83c. It is prevented that the document discharged from the upper discharge port 97 is pulled again into the ADF 12 from the lower discharge port 98, and excellent discharge of the document is realized.

When the flap 130 is pressed by the document discharged from the lower discharge port 98, the lower discharge port 98 is opened. Accordingly, the flap 130 does not prevent the document from being discharged from the lower discharge port 98. A driving device to open and close the flap 130 is unnecessary.

The flap 130 includes the charge removal brush 132. The document discharged from the lower discharge port 98 contacts with the charge removal brush 132 and the electricity is removed while the document is discharged from the lower discharge port 98. The alignment of the document discharged from the lower discharge port 98 is not disturbed by static electricity. The alignment of the document is not disturbed and the page order is not changed, and the document is stacked on the storage tray 14 in an excellently aligned state.

Next, a second embodiment will be described. The second embodiment is different from the first embodiment in the structure of triple paper discharge rollers. The others are the same as those of the first embodiment. In the second embodiment, the same structure as that explained in the first embodiment is denoted by the same reference numeral and its detailed explanation will be omitted.

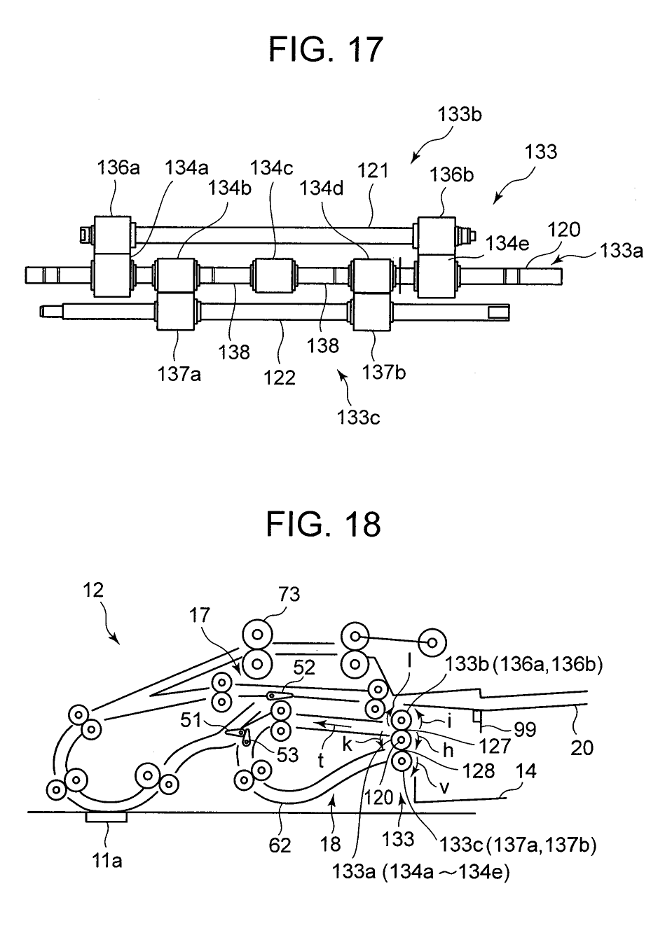

In the second embodiment, in order to prevent a document from again being pulled into an ADE 12 from a lower discharge port 98, paper discharge rollers 133 shown in FIG. 17 are used instead of the paper discharge rollers 83 of the first embodiment. The paper discharge rollers 133 include a drive roller 133a, an upper driven roller 133b, and a lower driven roller 133c. In the paper discharge rollers 133, an upper discharge port 127 as a first discharge port is formed between the drive roller 133a and the upper driven roller 133b. In the paper discharge rollers 133, a lower discharge port 128 as a second discharge port is formed between the drive roller 133a and the lower driven roller 133c.

The drive roller 133a of the paper discharge rollers 133 includes a fourth to an eighth drive rollers 134a, 134b, 134c, 134d and 134e on a drive shaft 120. The upper driven roller 133b includes upper driven rollers 136a and 136b on an upper shaft 121. The lower driven roller 133c includes a fourth and a fifth lower driven rollers 137a and 137b on a lower shaft 122. The upper driven rollers 136a and 136b respectively contact with the fourth and the eighth drive rollers 134a and 134e as the first side drive rollers and are driven. Further, an upper driven roller (not shown) coming in contact with the sixth drive roller 134c may be provided. The lower driven rollers 137a and 137b respectively contact with the fifth and the seventh drive rollers 134b and 134d as the third side drive rollers and are driven.

The fifth and the seventh drive rollers 134b and 134d are attached to the drive shaft 120 through one-way clutches 138 as power transmission members. The one-way clutch 138 transmits the rotation of the drive roller 133a only in one direction to the lower driven roller 133c.

As shown in FIG. 18, when the drive shaft 120 forwardly rotates in an arrow h direction, the fourth and the eighth drive rollers 134a and 134e rotate in the arrow h direction. The fifth and the seventh drive rollers 134b and 134d run idle by the action of the one-way clutches 138. The upper driven rollers 136a and 136b are driven by the fourth and the eighth drive rollers 134a and 134e, and rotate in an arrow i direction. At this time, the lower driven rollers 137a and 137b do not rotate.

Accordingly, at the time of the forward rotation of the drive shaft 120, the drive roller 133a and the upper driven roller 133b are used and the document can be discharged from the upper discharge port 127 in a first direction. While the document is discharged from the upper discharge port 127, the rotation of the lower driven roller 133c is stopped at the lower discharge port 128. Accordingly, even if the document discharged from the upper discharge port 127, which contacts with the drive roller 133a or the lower driven roller 133c, the document is not pulled into the ADF 12 side from the lower discharge port 128.

At the time of both-sided reading, when the drive shaft 120 is reversely rotated in an arrow k direction in order to reverse and feed the document in a second direction after both-sided reading, the fourth to the eighth drive rollers 134a to 134e are rotated in the arrow k direction. The upper driven rollers 136a and 136b are respectively driven by the fourth and the eighth drive rollers 134a and 134e, and are rotated in an arrow 1 direction. The lower driven rollers 137a and 137b are respectively driven by the fifth and the seventh drive rollers 134b and 134d, and are rotated in an arrow v direction.

The document after completion of both-sided reading is reversed and fed in the second guide 62 similarly to the first embodiment by using the fourth and the eighth drive rollers 134a and 134e and the upper driven rollers 136a and 136b, and is fed to the lower discharge port 128 via the paper discharge path 18. The reversed document is discharged from the lower discharge port 128 to the storage tray 14 by using the fifth and the seventh drive rollers 134b and 134d and the lower driven rollers 137a and 137b.

According to the second embodiment, the fifth and the seventh drive rollers 134b and 134d of the triple paper discharge rollers 133 including the upper discharge port 127 and the lower discharge port 128 are attached to the drive shaft 120 through the one-way clutches 138. While the document is discharged from the upper discharge port 127, the ADF 12 stops the rotation of the lower driven rollers 137a and 137b of the lower driven roller 133c. Thus, it is prevented that the document discharged from the upper discharge port 127 is pulled into the ADF 12 from the lower discharge port 128. Further, similarly to the first embodiment, the flap 130 including the charge removal brush which contacts with the document discharged from the lower discharge port 128 to the storage tray 14 is attached to the drive roller shaft 120, so that the electricity of the document is removed. The alignment of the document is not disturbed by static electricity, and the document is stacked on the storage tray 14 in an excellently aligned state.

Next, a third embodiment will be described. The third embodiment is different from the first embodiment in the structure of a paper discharge path. The others are the same as those of the first embodiment. In the third embodiment, the same structure as that explained in the first embodiment is denoted by the same reference numeral and its detailed explanation will be omitted.

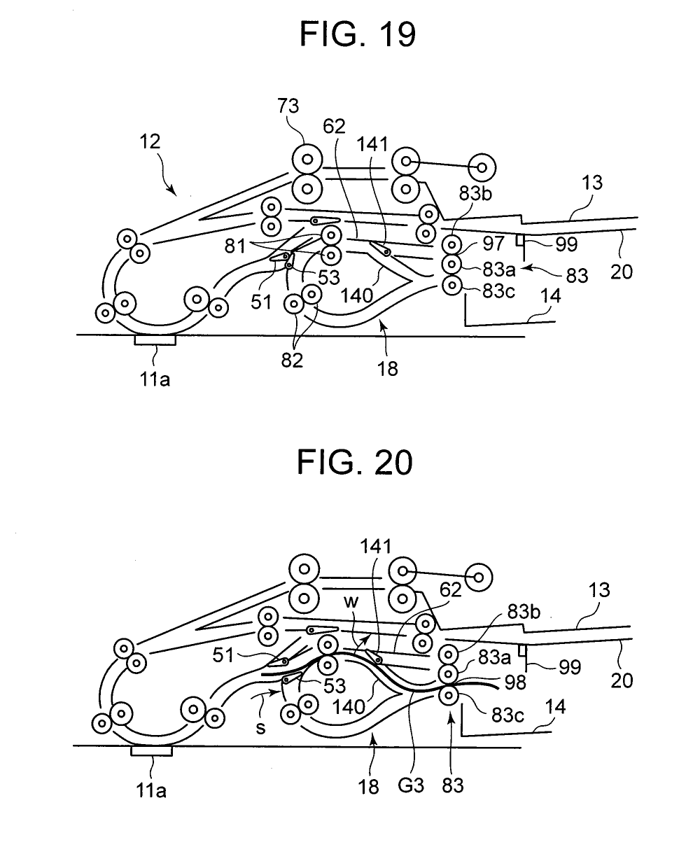

In the third embodiment, as shown in FIG. 19, an ADF 12 includes a paper discharge bypass 140 as a bypass member in a second guide 62 of a paper discharge path 18. The ADF 12 includes a gate 141 as a gate member between a paper discharge intermediate roller 81 and a paper discharge rollers 83 and at a branch point between the second guide 62 and the paper discharge bypass 140. The gate 141 distributes the document advancing in the direction of the paper discharge path 18 after completion of reading by the scanner 11 to the upper discharge port 97 side or the paper discharge bypass 140 side.

As shown in FIG. 20, at the time of one-sided reading, the gate 141 rotates in an arrow w direction. By the rotation in the arrow w direction, the gate 141 blocks the upper discharge port 97 direction of the second guide 62 and guides a document G3 to the paper discharge bypass 140. The document G3 passes through the READ document glass 11a and after one-sided reading is completed, the document advances in the direction of the paper discharge path 18. The document G3 is distributed in the direction of the paper discharge bypass 140 by the gate 141 in the second guide 62. The document G3 passes through the paper discharge bypass 140, and reaches a nip between a drive roller 83a and a lower driven roller 83c of paper discharge rollers 83. The document G3 is discharged from a lower discharge port 98 of the paper discharge rollers 83 to a storage tray 14.

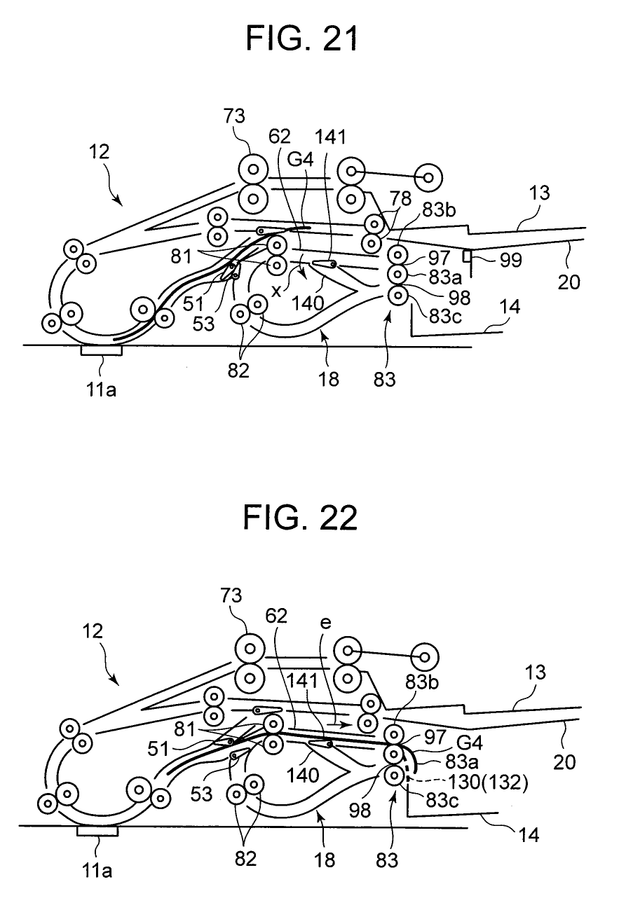

At the time of both-sided reading, as shown in FIG. 21, the gate 141 rotates in an arrow x direction. By the rotation in the arrow x direction, the gate 141 blocks the inlet of the paper discharge bypass 140. At the time of both-sided reading, after an image of a first side of a document G4 is read by the scanner 11, in order to read an image of a second side, the document G4 is again fed in the direction of the scanner 11 similarly to the first embodiment. As shown in FIG. 21, in order to read the image of the second side, the document G4 is temporarily fed in the direction of the reverse tray 20 by a reverse roller 78.

Thereafter, similarly to the first embodiment, the reverse roller 18 is reversed and driven, and the feeding direction of the document G4 temporarily fed in the direction of the reverse tray 20 is switched back in the direction of the reverse path 17.

Similarly to the first embodiment, after the ADE 12 reads the image of the second side of the switched back document G4 at the position of the READ document glass 11a, the document G4 is fed in the direction of the paper discharge path 18. Similarly to the first embodiment, as shown in FIG. 22, the ADF 12 feeds the document G4, which runs in the second guide 62 of the paper discharge path 18, in an arrow e direction by the drive roller 83a and the upper driven roller 83b. When the ADE 12 temporarily discharges a part of the document G4 from the upper discharge port 97 of the triple paper discharge rollers 83 at a place above the storage tray 14, an end of the document G4 may hang down in the direction of the lower driven roller 83c. However, at this time, since the flap 130 covers the lower discharge port 98 of the triple paper discharge rollers 83, as indicated by a doted line in FIG. 22, it is prevented that the document G4 hanging down from the upper discharge port 97 contacts with the lower driven roller 83c and is pulled in the direction of the paper discharge path 18 from the lower discharge port 98.

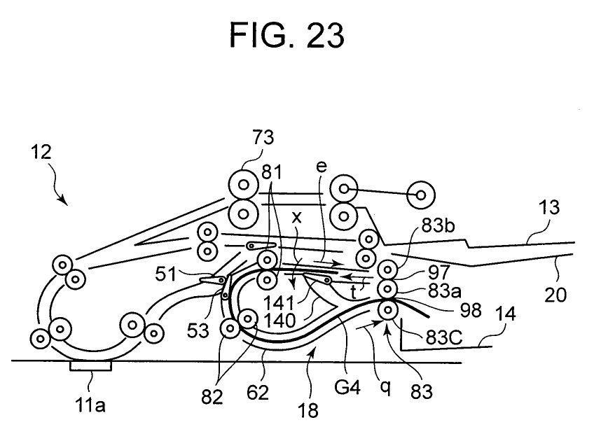

Thereafter, similarly to the first embodiment, in order to reverse the document G4, the drive roller 83a is reversely rotated. As shown in FIG. 23, the document G4 is reversed in an arrow t direction by using the drive roller 83a and the upper driven roller 83b. The ADF 12 discharges the reversed document G4 to the storage tray 14 from the lower discharge port 98 of the discharge path 18 through the paper discharge intermediate roller 81 and the paper discharge reverse roller 82. The document G4 is stacked on the storage tray 14 while the first side is directed downward.

According to the third embodiment, the paper discharge bypass 140 is formed in the second guide 62 of the reverse path 18. At the time of one-sided reading, the document G3 after completion of the reading is discharged from the lower discharge port 98 through the paper discharge bypass 140. In both the one-sided reading and both-sided reading, the document is discharged from the lower discharge port 98. The ADF 12 certainly prevents the pulling-in of the document from the lower discharge port 98, which may occur when the document is discharged from the upper discharge port 97.

Further, similarly to the first embodiment, since the flap 130 is provided with the charge removal brush 132, the alignment of the document G4 is not disturbed by static electricity, and the document is stacked on the storage tray 14 in an excellently aligned state.

The present invention is not limited to the above embodiments, but can be variously modified within the scope of the invention. For example, the attachment of the covering member, and the structure of the first to the third rotation members are not limited. As long as the covering member prevents the pulling-in of the document discharged from the first discharge port, and does not prevent the discharge of the document from the second discharge port, the shape, structure and the like thereof are not limited. The charge removal member may be a fiber brush or the like.

What is claimed is:

1. An auto document feeding device, comprising:
a first rotation member which can feed a document passing through a reading member in a first direction and a second direction opposite to the first direction;
a second rotation member to drive the first rotation member;
a third rotation member which is positioned below the first rotation member through the second rotation member and is driven by the second rotation member;
a reverse feeding member to feed the document from a first discharge port for discharging the document in the first direction by using the first rotation member and the second rotation member to a second discharge port for discharging the document by using the second rotation member and the third rotation member;
a placing member on which the document discharged through the first discharge port in the first direction or the document discharged through the second discharge port is placed; and
a covering member to open and close an outlet side of the second discharge port to the placing member.

2. The device of claim 1, wherein the second discharge port discharges the document fed by the reverse feeding member from the first discharge port.

3. The device of claim 1, wherein the covering member covers the outlet side by its own weight, and is rotated in a direction of opening the outlet side by being pressed by the document discharged through the second discharge port.

4. The device of claim 1, wherein the covering member is swingably attached to the second rotation member.

5. The device of claim 1, wherein the covering member includes a charge removal member to remove electricity of the document passing through the second discharge port.

6. The device of claim 5, wherein the charge removal member is a contact type charge removal member which is attached to the covering member and comes into slide contact with the document.

7. The device of claim 6, wherein a part of the contact type charge removal member extends to an attachment section to attach the covering member to the second rotation member, and contacts with the second rotation member through a conductive bearing member.

8. The device of claim 5, further comprising a power transmission member which intervenes between the second rotation member and the third rotation member, prevents forward rotation of the second rotation member, which drives the first rotation member in the first direction, from being transmitted to the third rotation member, and transmits reverse rotation of the second rotation member to the third rotation member.

9. The device of claim 8, wherein the second rotation member includes a first side drive roller which contacts with only the first rotation member and a third side drive roller which contacts with only the third rotation member, and the power transmission member is a one-way clutch which intervenes between a drive shaft of the second rotation member and the third side drive roller.

10. The device of claim 5, further comprising:
a bypass member which is provided in the reverse feeding member and guides the document, which passes through the reading member and is directed to the first discharge port, to the second discharge port, and
a gate member to distribute the document, which is directed to the first discharge port, to the first discharge port or the bypass member.

11. The device of claim 10, wherein the gate member distributes the document, which is to be discharged to the placing member, to the bypass member and distributes the document, which is to be reversed and fed in the second direction by the first rotation member and the second rotation member, to the first discharge port.

12. An image reading apparatus comprising:
a reading member to read a document;
a first rotation member which can feed a document passing through the reading member in a first direction and a second direction opposite to the first direction;
a second rotation member to drive the first rotation member;
a third rotation member which is positioned below the first rotation member through the second rotation member and is driven by the second rotation member;
a reverse feeding member to feed the document from a first discharge port for discharging the document in the first direction by using the first rotation member and the second rotation member to a second discharge port for discharging the document by using the second rotation member and the third rotation member;
a placing member on which the document discharged through the first discharge port in the first direction or the document discharged through the second discharge port is placed; and
a covering member to open and close an outlet side of the second discharge port to the placing member.

13. The device of claim 12, wherein the second discharge port discharges the document fed by the reverse feeding member from the first discharge port.

14. The device of claim 12, wherein the covering member covers the outlet side by its own weight, and is rotated in a direction of opening the outlet side by being pressed by the document discharged through the second discharge port.

15. The device of claim 12, wherein the covering member includes a charge removal member to remove electricity of the document passing through the second discharge port.

16. The device of claim 15, further comprising a power transmission member which intervenes between the second rotation member and the third rotation member, prevents forward rotation of the second rotation member, which drives the first rotation member in the first direction, from being transmitted to the third rotation member, and transmits reverse rotation of the second rotation member to the third rotation member.

17. The device of claim 15, further comprising:
a bypass member which is provided in the reverse feeding member and guides the document, which passes through the reading member and is directed to the first discharge port, to the second discharge port, and
a gate member which distributes the document, which is directed to the first discharge port and is to be discharged to the placing member, to the bypass member and distributes the document, which is to be reversed and fed in the second direction by the first rotation member and the second rotation member, to the first discharge port.

18. A document feeding method, comprising:
discharging a document passing through a reading member to a placing member from one of an upper first discharge port and a lower second discharge port of a triple roller member including an upper first rotation member, a lower third rotation member and a second rotation member sandwiched between the first and the third rotation members;
covering an outlet side of the second discharge port by a covering member when the document is discharged from the first discharge port; and
opening the outlet side when the document is discharged from the second discharge port.

19. The method of claim 18, wherein electricity of the document is removed by the covering member while the document is discharged from the second discharge port, and
rotation of the third rotation member by rotation of the second rotation member is stopped when the document is discharged from the first discharge port.

20. The method of claim 18, wherein
electricity of the document is removed by the covering member while the document is discharged from the second discharge port,
the document is discharged from the second discharge port to the placing member in one-sided reading; and
in both-sided reading, after a part of the document is discharged from the first discharge port, the document is switched back and is discharged from the second discharge port to the placing member.
